(19) United States
(12) Patent Application Publication
(10) Pub. No.: US 2003/0095525 A1
(43) Pub. Date: May 22, 2003

(54) Navigation control unit for a wireless computer resource access device, such as a wireless web content access device

(76) Inventors: Daniel Lavin, San Francisco, CA (US); Henriette Wendt, London (GB); Robert Cousins, Crawley (GB)

Correspondence Address: ST. ONGE STEWARD JOHNSTON & REENS, LLC, 986 BEDFORD STREET, STAMFORD, CT, 06905-5619, US

(21) Appl. No.: 10/269,162

(22) Filed: Oct. 11, 2002

Related U.S. Application Data
(63) Continuation of application No. PCT/US01/12168, filed on Apr. 12, 2001.

(30) Foreign Application Priority Data
Apr. 13, 2000 (GB) 0009004.3

(51) Int. Cl. H04Q 7/24

(52) U.S. Cl. 370/338; 370/352

(57) ABSTRACT

A navigation control unit for a wireless computer resource access device, such as a wireless web content access device, is disclosed. The navigation control unit includes a microprocessor that stores information regarding the navigation control unit. The microprocessor also processes user input received from a user. Input may be provided by any number of user input devices, such as button switches, voice activated commands, touch sensitive displays, and the like. The navigation control unit may be embodied as various components to be coupled with the wireless web content access device, such as a hands-free headset, a replaceable and rechargeable battery, a replaceable face plate, incorporated as hardware and/or software within the wireless device, etc. Furthermore, the navigation control unit may include additional functionality, such as audio source or playback devices, memory, positioning systems, biometric readers, data collection devices, etc. The navigation control unit may be separated into two portions, one of which is coupled to the wireless web content access device, and the other of which is a separate portion that communicates wirelessly with the first portion. Various other alternatives are described.

### CROSS-REFERENCE TO RELATED APPLICATION

This application claims the benefit of U.K. Patent Application No. GB 0009004.3, filed Apr. 13, 2000, currently pending.

### TECHNICAL FIELD

The present disclosure relates in general to a navigation control unit for use with a wireless computer resource access device.

### BACKGROUND

The Internet comprises a vast number of computers and computer networks interconnected through communication channels. The Internet is used for a variety of reasons, including electronic commerce, exchanging information such as electronic mail retrieving information and doing research, and the like. Many standards have been established for exchanging information over the Internet, such as electronic mail, Gopher, and the World Wide Web (“WWW”). The WWW service allows a server computer system (i.e., web server or website) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g., PDA's).

Recently, portable communication devices such as mobile telephones have been developed to access information on a local or global computer network. These devices come in many different forms including, for example, mobile telephone or palm top computers, and will be referred to generally as wireless web access devices.

Customers of the wireless web access device desire to have devices that provide a large amount of functionality and yet are small, lightweight, and affordable. To accommodate these conflicting desires, manufacturers have made the user controls smaller and have designed each one to perform potentially a variety of functions. For example, many wireless web access devices require users to press a small button up to three times in order to input just one character. Moreover, users often have to navigate through a large number of websites or levels of websites, requiring a large number of often cumbersome inputs. Accordingly, it is desired to increase both the functionality and ease of use of wireless web access devices.

U.S. Pat. No. 5,854,624 to Grant, issued Dec. 29, 1998 (“Grant”) discloses a pocket-sized user interface for accepting user input for a separate Internet browser terminal designed to, among other things, reduce carpal tunnel syndrome for people using traditional computer keyboards to browse the Internet on their personal computer. The user interface of Grant must be less than 0.45 inches in thickness and roughly the length, width, and shape of a standard credit card. The interface is connected to a browser terminal via a translator, which converts the commands to a form acceptable to the browser terminal, and the translator is preferably connected to both the browser terminal and the user interface with a cord. The buttons on Grant are programmed to provide linking commands to a variety of websites. The user interface of Grant, however, is plagued with problems. For example, the user interface Grant is severely limited in size, shape and functionality and requires the use of a translator. In addition, Grant only discloses buttons programmed on the user interface itself limiting its usefulness relative to the present invention. These are only some of the problems associated with Grant.

Most wireless web access device users are unsophisticated in the operation of such devices, and thus have difficulty reconfiguring them to select a new home page (if this is possible) or even access other web pages. Even if users are capable of operating the device, navigating to desired web pages can be difficult, often involving a complex string of key presses. Thus, users find it difficult to both customize their wireless web access devices and navigate to desired web pages. Furthermore, many of the wireless web access devices are not general purpose computing devices for browsing or web surfing, but instead are task driven for a small set of preferred tasks for the user. These tasks are horizontal across groups of people, such as electronic mail calendar, address book, and the like. Content on the worldwide web, however, is much more segmented to specific user groups interested in the particular content provided by a particular site. Thus, there is a discontinuity between wireless web access devices and the content to which they allow users access.

### BRIEF DESCRIPTION OF THE DRAWINGS

FIG. 1 is schematic view of a wireless web access device with a first preferred embodiment of a navigation control unit.

FIG. 2 is a schematic view of a second preferred embodiment of the navigation control unit.

FIG. 3 is a schematic view of a third preferred embodiment of the navigation control unit.

FIG. 4 is a schematic view of a preferred control circuit of the navigation control unit.

FIG. 5 is a flowchart showing a preferred method of operation of the navigation control unit.

FIG. 6 is a flowchart showing a preferred method for providing higher-level functionality in the navigation control unit.

FIG. 7 is a digitized image of an example of a wireless web access device according to the third preferred embodiment of FIG. 3.

FIG. 8 is a front view of an alternative embodiment of the navigation control unit employing a thumb pad.

FIG. 9 is a front view of an alternative navigation control unit employing a thumb wheel.

FIG. 10 is a front view showing an alternative navigation control unit employing a touch sensitive LCD.

FIG. 11 is an alternative embodiment of the navigation control unit employing a touch sensitive screen.

FIG. 12 is a block diagram illustrating an alternative embodiment of the navigation control unit employing multi-colored light emitting elements and a battery.

FIG. 13 is a block diagram illustrating an alternative embodiment of the navigation control unit employing a key switch matrix disposed in separate housing coupled wirelessly to another portion connected to the wireless web access device.

FIG. 14 is a block diagram illustrating another alternative embodiment of the navigation control unit having a FM receiver, MP3 player, or both.

FIG. 15 is a block diagram illustrating another alternative embodiment of the navigation control unit for processing voice commands.

FIG. 16 is a block diagram illustrating another alternative embodiment to the navigation control unit having removable modules.

FIG. 17 is an isometric diagram illustrating an alternative embodiment of the navigation control unit disposed within a removable battery for the wireless web access device.

FIG. 18 is an isometric diagram illustrating another alternative embodiment of the navigation control unit as disposed in a removable face plate for the web access device.

FIG. 19 is a block diagram of a suitable computer for employing aspects of the invention.

FIG. 20 is a diagram illustrating an alternative embodiment employing a cable connector between the navigation control unit and the wireless device.

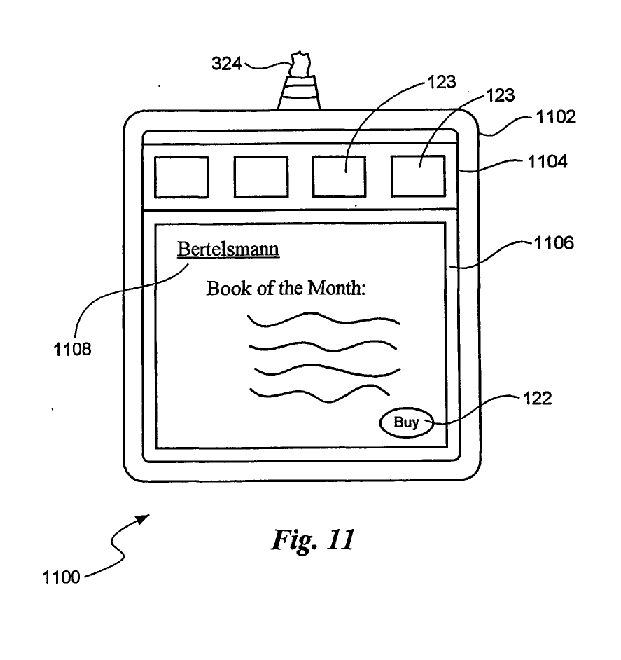

In the drawings, identical reference numbers identify identical or substantially similar elements or acts. To easily identify the discussion of any particular element or act, the most significant digit or digits in a reference number refer to the Figure number in which that element is first introduced (e.g., element 1104 is first introduced and discussed with respect to FIG. 11).

The headings provided herein are for convenience only and do not necessarily affect the scope or meaning of the claimed invention.

### DETAILED DESCRIPTION

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Depicted embodiments of the invention are intended for use with any suitable portable wireless web access device 110. By way of example, the preferred embodiments will be described with reference to a portable communication device such as a mobile telephone, Internet-enabled PDA, automobile-based web access device, or other portable or mobile communication devices. Suitably, the mobile telephone is a cellular telephone such as a Global System for Mobile Communications (“GSM”) device, preferably operating under the wireless application protocol (“WAP”), General Packet Radio Service (“GPRS”), Third Generation Mobile System (“3G)”, I-mode or similar communications protocol. The web access device 110 typically has a display screen 111 and integral user controls 112 which are suitably buttons such as membrane switches.

Under a communications protocol such as WAP, the web access device 110 is used to access a wide range of information on databases linked by a global computer network such as the Internet. The web access device 110 uses a browser function to access the Internet 115 through a gateway portal 114. Navigation between sites and between pages of a site is performed using the integral control buttons 112 to control a browser function of the web access device 110. Often it is desired to make the web access device 110 as small as possible and a problem arises in that the integral control buttons 112 become smaller and more difficult to operate. Further, it is desired to keep the number of user controls to a minimum for space and cost, but by contrast it is also desired to increase the number of functions available on the device. As a result, each integral control button 112 typically performs a number of different functions often operated by pressing the same button several times or by pressing control buttons in various different combinations. Often, a user must navigate a menu structure in order for the web access device to perform a desired function. It has been found that a menu structure having more than one or two levels is particularly difficult for users to navigate.

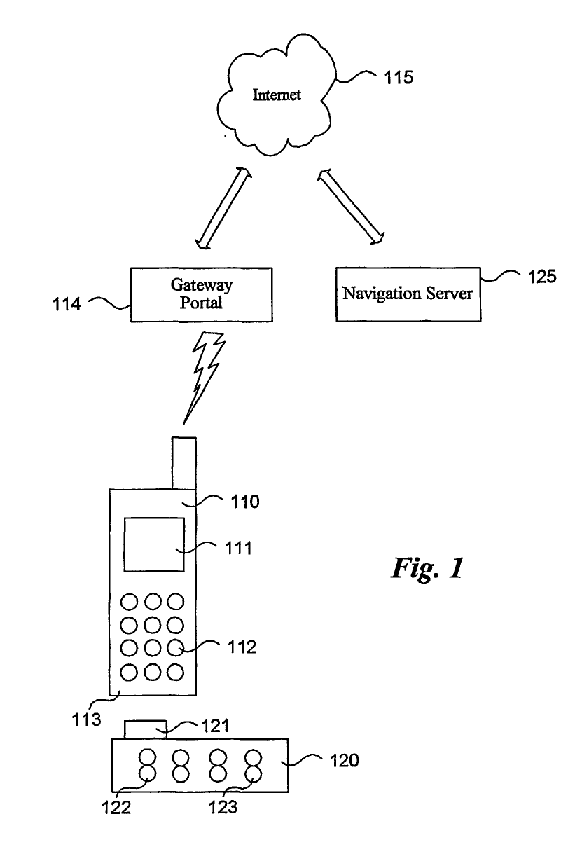

Referring to FIG. 1, a first embodiment provides a navigation control unit 120 that is coupleable to the wireless web access device 110. (The terms “wireless access device”, “wireless device”, “web access device”, and similar terms are generally used interchangeably herein.) In this embodiment, the navigation control unit 120 is coupleable directly to the web access device 110 such as by a connector 121 entering a corresponding port 113 on the web access device 110. The connector 121 provides both electrical and mechanical coupling between the navigation control unit 120 and the web access device 110. The port 113 in this example is shown at the bottom of the web access device 110, but can be provided elsewhere on the device or remote therefrom such as on an adapter lead.

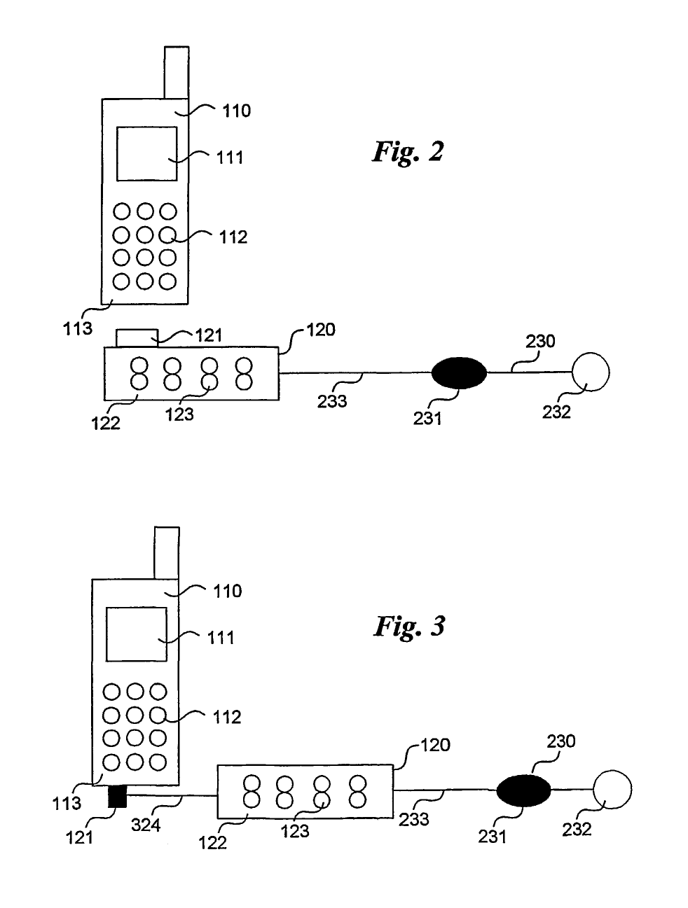

FIG. 2 shows a second embodiment wherein the navigation control unit 120 comprises a hands-free unit 230 including a microphone 231 and an earpiece 232. Suitably, the handsfree unit 230 is coupled to the navigation control unit 120 by a communication link such as a cord 233. Alternatively, a local wireless link is provided for communication between the navigation control unit 120 and the hands-free unit 230, such as by using optical, infrared, or radio frequency signals.

FIG. 3 shows a third embodiment where the navigation control unit 120 is provided remote from the wireless web access device 110 linked by a communication link such as a cord 324 or a local wireless link. Conveniently, in this embodiment the web access device 110 may be carried about a user's person such as in a pocket, the navigation control unit 120 may be carried separately such as in the hand, on a belt, or on a jacket lapel, and the handsfree unit 230 may be provided about the user's head.

Under an alternative embodiment (not shown), the hands-free unit 230 is omitted. As a result, the navigation control unit 120 is coupled to the web access device 110 by the cord 324 and provides the same benefits as those in the third embodiment.

Under another alternative embodiment, the navigation control the unit 120 is embodied or incorporated within the wireless device 110. Under this alternative embodiment, the navigation control unit may the embodied as additional circuitry and hardware (including user input buttons) incorporated into the wireless device, and/or software stored in memory within the wireless device. Thus, the functionality and features described herein may be embodied directly within the wireless device.

The navigation control unit 120 provides at least one user control 122 and preferably, a plurality of user controls as illustrated These user controls 122 on the navigation control unit 120 are remote from the integral control buttons 112 provided on the web access device 110. The user controls 122 may take any suitable form, such as keys formed (e.g., membrane switches). Further information regarding construction of the navigation control unit may be found in the U.S. patent application Ser. No. ______, entitled “Hardware Configuration For A Navigation Control Unit For A Wireless Computer Resource Access Device, Such As A Wireless Web Content Access Device,” filed concurrently herewith.

Unless described otherwise herein, the construction and operation of the various blocks shown in FIGS. 1-3 and the other Figures are of conventional design. As a result, such blocks need not be described in further detail beyond that provided herein because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein. Furthermore, much of the detailed description provided herein is explicitly disclosed in the above patent application. Most or all of the additional material of aspects of the invention will be well known to or recognized by those skilled in the relevant art as being inherent in the detailed description provided in such patent application. Those skilled in the relevant art can implement aspects of the invention based on FIGS. 1-3 and the detailed description provided in the above patent application.

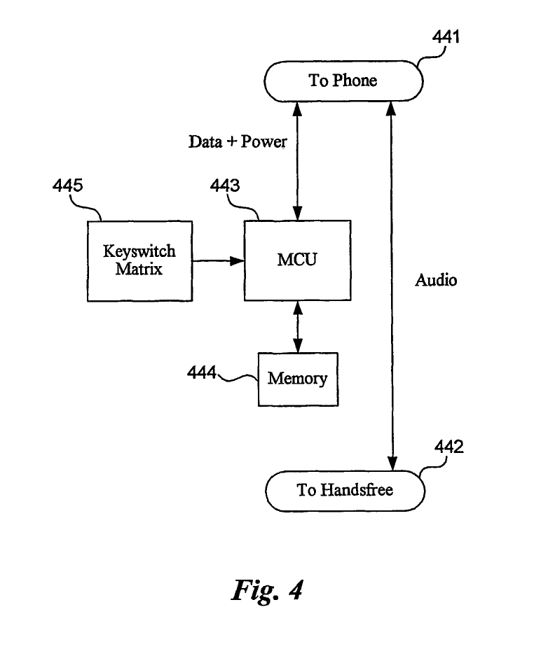

FIG. 4 shows a suitable circuit construction for the navigation control unit 120. A first input/output (“i/o”) port 441 communicates with the wireless web access device 110. In one example, the i/o port 441 uses an RS232 communications interface. Communications are governed by a protocol such as GSM07.07. Power, for example at +3.3V or +5V and GND, is drawn through the port 441 from the wireless web access device 110. Alternatively, an independent power source may be provided as part of the navigation control unit. The independent power source may be any suitable power source, including but not limited to batteries, solar-generated power, or power provided by another device, such as an automobile cigarette lighter, a wall outlet, or a power source associated with a personal computer. Suitably, audio signals are passed directly from the first i/o port 441 to a second i/o port 442. The second i/o port 442 is coupled to the handsfree unit 230.

The navigation control unit 120 comprises a microprocessor 443 for executing instructions stored on an internal or external memory such as an EPROM and coupled to internal or external storage or memory 444 such as SDRAM. The microprocessor is coupled to the user controls 122 such as through a keyswitch matrix 445. Further details regarding the circuit construction and alternatives are provided below.

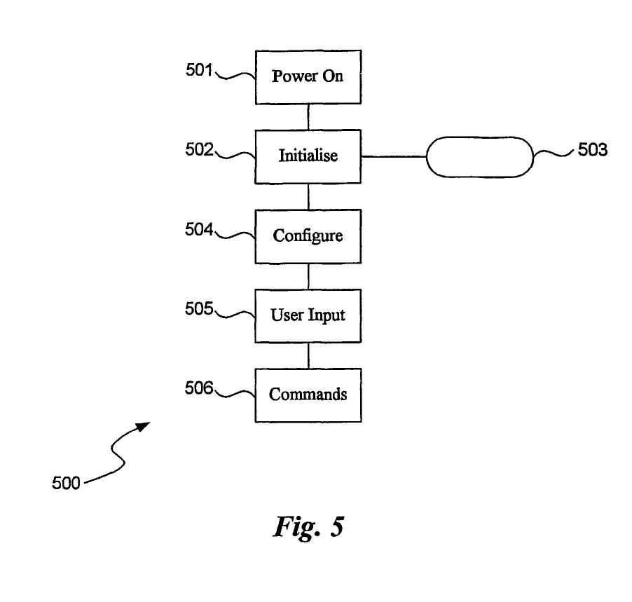

Operation of the navigation control unit 120 will now be described with reference to a routine 500 shown in FIG. 5. Each of the blocks depicted in FIG. 5 and the other flowcharts is of a sub-operation type that is either well known in the art or may be implemented by those skilled in the relevant art based on the detailed description provided herein. Each block may well include a sequence of operations that need not be described herein. Those skilled in the relevant art can create source code, microcode, or otherwise implement the invention based on the flowchart of FIG. 5 and the detailed description provided herein for operating the navigation control unit. The routine 500 is preferably stored in non-volatile memory that forms part of the microprocessor 443 or memory 444, or can be stored in removable media, such as disks, or hardwired or preprogrammed in chips, such as EEPROM semiconductor chips. Those skilled in the relevant art will appreciate that some or all of the routine 500 and other functions and methods described herein can be performed by an application specific integrated circuit (ASIC) or a digital signal processing (DSP) integrated circuit through conventional programmed logic arrays or other circuit elements.

In block 501, the navigation control unit 120 is powered on, such as by the navigation control unit 120 being connected to the web access device 110 or by the web access device 110 being turned on. In block 502, communications with the web access device 110 are initialized. For example, communication settings such as baud rate are negotiated. An identify request may be sent to the web access device 110 and a reply received which gives identity information about the web access device 110 such as make and model information. If the identity information is not received or is not recognized, operation ends in block 503.

In block 504, the navigation control unit 120 optionally sets configuration parameters of the web access device 110 using configuration commands.

In block 505, the navigation control unit 120 waits for user input such as by polling the keyswitch matrix 445. In response, in block 506 the navigation control unit 120 sends control commands to the web access device 110.

Operation continues until power to the navigation control unit 120 is removed, such as when the navigation control unit 120 is disconnected from the web access device 110 or when the web access device 110 is turned off.

The configuration commands in block 504 are used to set a wide variety of configuration parameters of the web access device 110. The configuration parameters are determined by the nature and type of the web access device 110. In the example of a GSM cellular device, the web access device 110 dials a predetermined network number when attempting to establish a connection to the Internet through a predetermined gateway portal. The gateway portal is one example of a configuration parameter that may be set by the navigation control unit 120. Other configuration parameters may set screen displays including predetermined logos and advertising information to appear on the display screen 111. Still other configuration parameters of the web access device 110 include, for example, a home page, bookmarks stored by the web access device 110, and a ringing tone of the web access device 110. The navigation control unit 120 conveniently sets these and other configuration parameters of the web access device 110 for the user automatically and requires minimal or even no user input. Advantageously, the user avoids complicated button press arrangements and menu structures in the web access device 110. Also, where configuration parameters are sent over a live network connection, network bandwidth and network time is substantially reduced by the automatic operation of the navigation control unit 120 compared with manual keypresses of the integral control buttons 112.

The commands sent by the navigation control unit 120 represent a keypress sequence equivalent to a sequence of manual keypresses on the integral user control buttons 112. In the simplest example, each command sent to the web access device 110 is equivalent to a single press on one of the integral user control buttons 112. In most practical examples, each command is a string representing a predetermined sequence of keypresses. The keypress representation is preferably determined with reference to the identity information obtained in block 502 such that the navigation control unit 120 is able to operate with a wide variety of web access devices 110. Suitably, the keypress sequence is obtained with reference to a lookup table stored in the navigation control unit 120 such that each user control 122 maps to a plurality of stored keypress sequences and one of the keypress sequences is selected according to the identity information of the web access device 110. The keypress sequence is then used to form the command or a sequence of commands, depending upon the communication protocol required for communication with the identified web access device 110.

The user controls 122 monitored in block 505 perform any suitable function. The control commands sent in block 506 will now be described in more detail. A first group of the user controls 122 or keys represents the most commonly used navigation functions suitable for controlling the web access device 110 for navigation of a local or global computer network using commands such as back, forward, scroll up, scroll down, and select. This first group of keys may directly replicate equivalent control buttons 112 on the wireless web access device 110. It is advantageous to provide these simple user controls on the navigation control unit 120. In one embodiment, for example the keys of the navigation control unit 120 are easier to use than the integral control buttons 112 of the web access device 110 by being larger or having improved ergonomics.

Another group of the user controls 122 provides improved functionality over the integral control buttons 112. This second group of controls performs higher level functions. The navigation control unit 120 may have only the first group, only the second group, or preferably, both groups of user controls 122.

As described herein, one keypress on the user controls 122 of the navigation control unit 120 represents a plurality of button presses required to perform the equivalent function using the integral control buttons 112 of the web access device 110. The controls may perform a wide variety of higher level functions depending on the nature and type of the web access device 110.

As shown in FIG. 1, a selected one or more of the user controls 122 have pre-defined hot key controls 123, each having an associated hot key function. The hot key controls 123 each command the web access device 110 to open a connection to a particular website. Each of these hot key controls 123 links to a predetermined site such that the user may easily access a selected few predetermined sites very conveniently. Advantageously, the user obtains access to these predetermined websites without having to use or even understand other navigation controls on the wireless web access device 110 or on the navigation control unit 120.

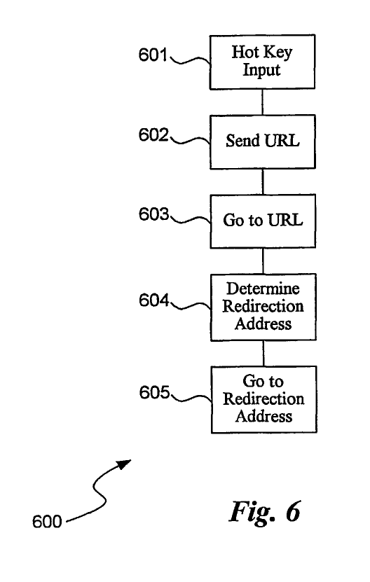

FIG. 6, as a routine 600, shows a preferred method for performing higher level controls such as the hot key function 123. At block 601 a hot key 123 is activated by the user.

At block 602 the navigation control unit 120 sends control commands to the web access device 110. These control commands may depend upon the current state of the web access device 110, for example to establish a web connection or open a browser function if required. The control commands include sending a URL. Conveniently, the URL is sent as a keypress sequence.

In one example, the URL comprises three fields. A first field gives a web address, preferably in a standard format such as “http://www.serveraddress.xxx”. A second field provides an identifier unique to the navigation control unit 120, or unique to a predetermined group of navigation control units, such as an alphanumeric sequence of 6, 8 or 10 characters allocated to the navigation control unit 120 during manufacture. In this example, the unique identifier is “XXX12345”. The third field identifies the hot key user control 123 activated by the user as determined in block 601. In this example, the user activated key number “3”. The complete URL is sent, for example, as the character sequence “http://www.serveraddress.x/xx12345/3”.

The URL may require a complicated keypress sequence. A web access device 110 may have integral control buttons 112 in a 4×3 number keypad layout where each number key is used to obtain an extended alphanumeric character set by repeated keypresses. For example, the “1” button is pressed twice to give the letter “A” or pressed three times to give the letter “B”. Hence, entering the URL manually requires many keypresses on the integral control buttons 12. In the above example, the URL contains 39 characters, each of which may require several button presses by the user on the integral user controls 112—typically at least 60 presses. By contrast, the user need only perform one keypress on the hot key control 123 of the navigation control unit 120 to achieve the same result, giving a significant advantage.

In block 603, the web access device 110 responds to the URL and attempts to access the web address identified by the URL using browser functions within the web access device 110. The first field preferably identifies a predetermined navigation server 125 which receives the URL request from the web access device 110.

In block 604, the navigation server 125 uses the second and third fields of the URL to determine a redirection address and returns the redirection address to the web access device 110. At block 605, the web access device 110 is redirected to the redirection address supplied from the navigation server 125. The redirection address is a second URL.

The redirection address is conveniently determined with reference to a lookup table stored on the navigation server 125. In this example, the second and third fields provide the information “XXX12345/3” and the redirection address is returned as a website corresponding to hot key control number “3” on navigation control unit 120 number “XXX12345”. The website may be visibly labeled on the hot key control 123 or adjacent thereto for the user. For example, the hot key control number “3” is labeled “weather” and the redirection address corresponds to a website giving weather information.

The redirection action takes place at the navigation server 125 such that the navigation control unit 120 is relatively dumb. Also, if the location of the desired website changes, or if it is desired to substitute another website, then reprogramming is performed centrally at the navigation server 125.

In a preferred embodiment, the navigation control unit 120 stores user specific information. Such information is delivered to the web access device 1110, for example when accessing a particular predetermined website from one of the hot key controls 123. Additionally or alternatively, such user information is supplied from the navigation control unit 120 in response to an interrogation signal issued from the web access device 110.

In a typical wireless web access device 110, navigation generally takes place using software controls within the device. However, in the preferred embodiment of the present invention, the navigation control unit 120 provides an external hardware controller to determine navigation of the wireless web access device 110. The navigation control unit 120 readily links to predetermined websites that are of interest to the user. The hot key controls 123 may be tailored to the needs of each user, such as providing financial, travel, sports or any other information, by changing the central lookup table or personalization table at the navigation server 125. The unique identifier allows each navigation control unit to have a different response based on the redirection addresses stored at the navigation server. Further information regarding navigation server operation and aspects of the navigation control unit may be found in the U.S. patent application Ser. Nos. ______ and ______, entitled “Software For A Navigation Control Unit For Use With A Wireless Computer Resource Access Device And Associated System” and “Navigation Server For Use With, For Example, A Wireless Web Access Device Having A Navigation Control Unit,” filed concurrently herewith. Rather than employ a thin client, under an alternative embodiment, the navigation control unit, wireless web access device, or both, employ a fat clients whereby most or all of the functions described above are performed locally by the navigation control unit and/or wireless web access device. Thus, the wireless web access device need not contact the navigation server under this alternative embodiment, but instead accesses a predetermined computer resource via a pre-programmed URL stored in the navigation control unit.

The navigation control unit 120 may take any suitable form factor. A generally rectangular box is shown in FIGS. 1, 2 and 3 merely for illustration. Likewise, the navigation control unit 120 may take any suitable size. In the first and second embodiments, at least the part of the navigation control unit 120 in the region of the connector 121 is sized and shaped to correspond with external contours of the web access device 110 in the region of the port 113, giving a neat visual appearance and assisting mechanical stability.

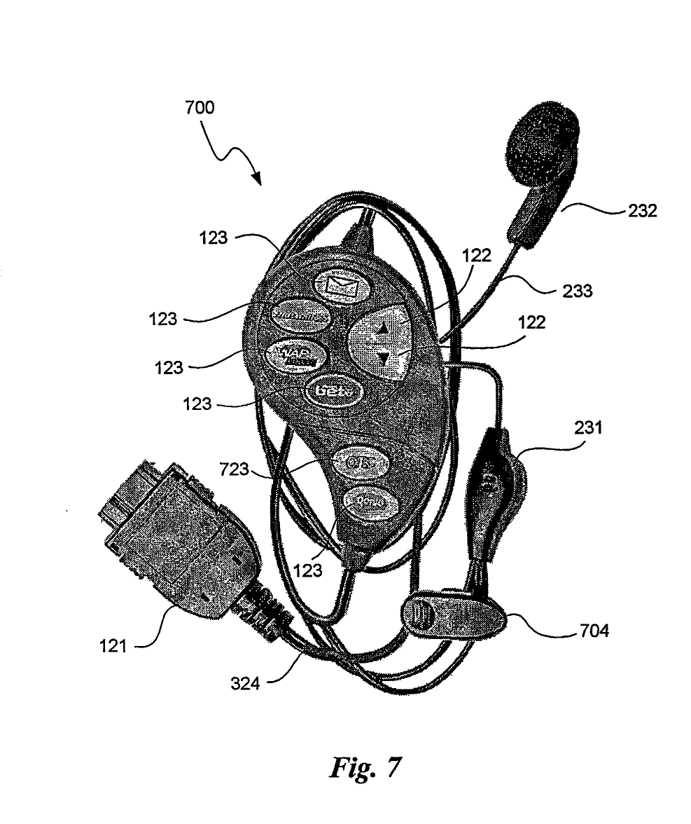

Referring to FIG. 7, an example of one external configuration for the navigation control unit 120 is shown as a unit 700. The unit includes a spring loaded clip 704 to permit a user to clip the cord 233 to the user's clothing. Each of the hot keys 123 includes a graphic depicting the website to which the hot key navigates, such as to an electronic mail site, to an Internet portal, or to other sites described herein. The user controls 122 correspond to up-and-down cursor buttons for navigating, such as within a web page displayed on the display screen 111, or backward and forward between previous and subsequent web pages. An enter, select or “OK” button 723 is provided to permit a user to enter or select a particular choice.

Now that one embodiment of the invention has been described in detail, various alternative embodiments will now be described. In general, alternatives and alternative embodiments described herein are substantially similar to previously described embodiments, and common elements and acts or steps are identified by the same reference numbers. Only significant differences in construction or operation are described in detail.

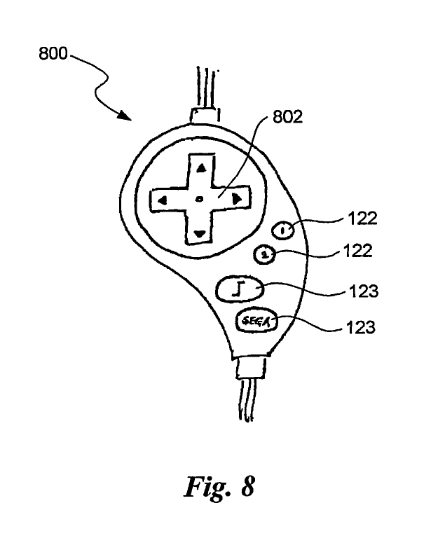

Referring to FIG. 8, an alternative navigation control unit is shown as a game playing unit 800. A thumb switch 802 dominates a central portion of the upper surface of the unit which allows a user to rapidly move along two axes, such as moving a game piece within the display screen 111. The user controls 122 correspond to functions common on game device consoles or game controllers. The hot keys 123 correspond to links to websites for playing games, such as multi-player computer games. Thus, the unit 800 is specifically designed to allow a user to play WAP enabled games over a wireless network.

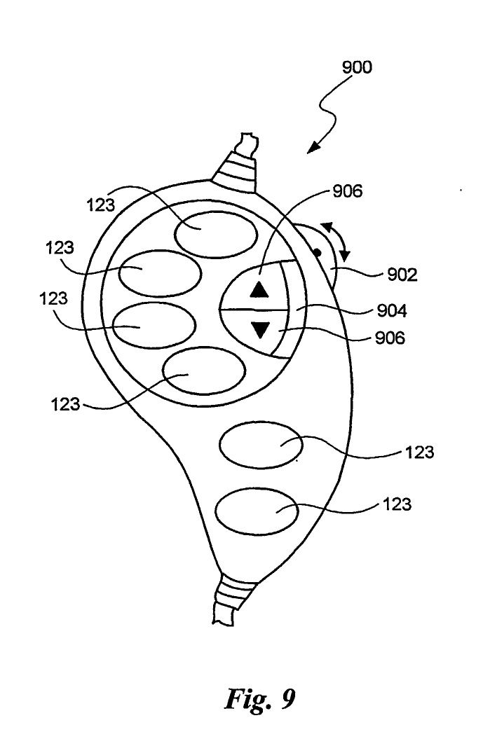

Referring to FIG. 9, an alternative navigation control unit is shown as a unit 900. The unit 900 is similar to the unit 700 (FIG. 7) except that it includes a thumb wheel 902. The thumb wheel 902 allows a user to quickly move a cursor or other object displayed on the display screen 111. The unit 900 may further include a switch within the unit that is actuated by pressing the thumb wheel inwardly with respect to the housing of the unit. A back or enter/select button 902 is provided next to up and down the navigation buttons 906.

The navigation control units 800 and 900 demonstrate additional types of user input devices that may be employed beyond simple buttons that a user depresses (as depicted in FIG. 3). Of course, any type of electromechanical transducer may be employed, such as a joystick, pressure sensitive switch, rocker switch, rotary pads, sliders, or other user input devices known by those skilled in the relevant art. As described herein, the user controls 122 may provide any kind of user input, including a request to link to a website, a scrolling or other control command, powering on or off, data entry, etc.

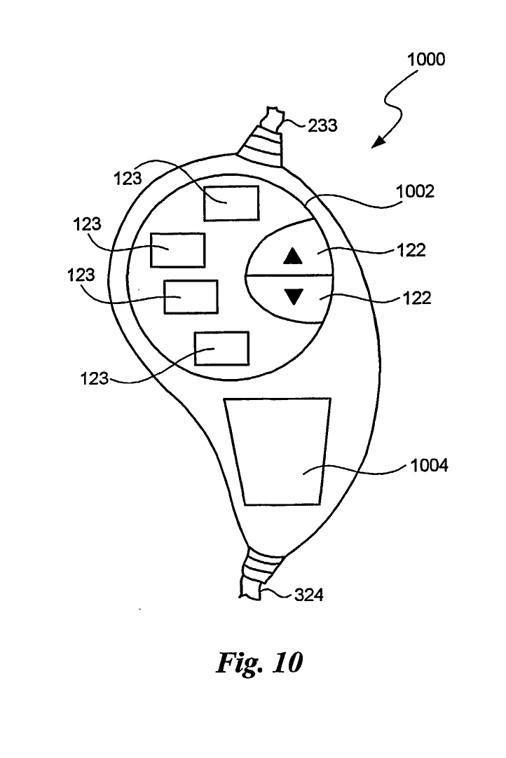

Referring to FIG. 10, an alternative navigation control unit 1000 is shown that employs a touch sensitive, liquid crystal display (“LCD”) 1002. The hot keys 123 and user controls 122 are displayed as “buttons” on the LCD 1002 that a user may select. A touch pad-type pointing device 1004, although other types of pointing devices may be employed, such as trackballs and the like.

FIG. 11 shows an alternative to the unit 1000 as a navigation control unit 1100. While the touch sensitive LCD 1000 has an ergonomic shape, the unit 1100 employs a generally rectangular touch sensitive LCD 1102 which may be more readily available and less expensive. The LCD 1102 includes an upper navigation portion that displays the hot keys 123 as icons, logos or pictograms. When the user or a third party changes a URL associated with one of the hot keys 123, the navigation control unit 126 or navigation server 125 may provide instructions or display descriptions for displaying a different icon for the hot key with respect to the new website to which the hot key is directed.

Alternatively, or additionally, the LCD 1102 may be changed to correspond with the current function of a user control 122. The function of each user control 122 in this embodiment would be designated by software instead of hardware. For example, the microprocessor may provide a browse signal to cause an appropriate browse button to be indicated on the LCD screen when a browser is being viewed on the wireless web access device 110, while the microprocessor may provide a purchase signal to thereby indicate on the LCD screen a buy button when an e-commerce application is being viewed.

A display window 1106 displays content such as web pages (which may be similar to content displayed in the display screen). For example, the display window 1106 may display an advertisement from a retailer who is selling a product or service displayed in the display window as a listing for a book of the month. A user control 122 is shown as a “Buy” button. In response to a user selecting the buy button, the navigation control unit instructs the navigation server 125 to place an order with the advertiser to purchase the displayed book. The navigation server provides the user's credit card number to the advertiser, where the credit card number is stored in a personalization table stored at the navigation server. Alternatively, the user's credit card number may be stored locally in the navigation control unit, or input manually by the user, and transmitted only when the user selects the buy button.

Of course, features such as the use of a buy button may be employed in any of the navigation control units described herein and need not be employed with a touch sensitive screen. For example, the user control 122 in another embodiment described herein could be configured as a “purchase” button and a command would be sent to an appropriate e-commerce web page requesting purchase of a product A retailer could sell navigation control units 120 that contained a user control 122 programmed to purchase, say, the book-of-the-month and proceed to complete the e-commerce transaction based on payment and delivery information stored on a server. In an alternative embodiment, an electronic cash chip or e-wallet coupled with the navigation control unit 120 could be used to provide payment.

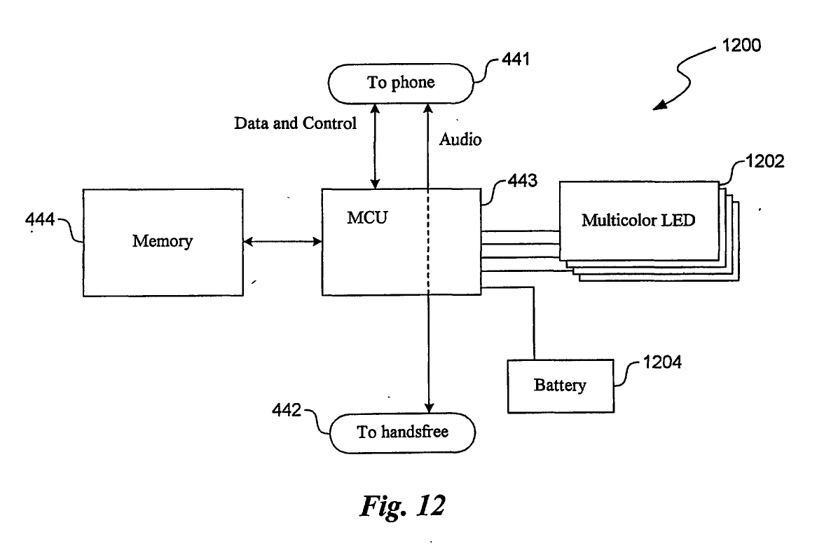

Referring to FIG. 12, another alternative embodiment shown as a navigation control unit 1200 replaces the touch sensitive LCD with one or more multicolored light emitting diodes (LEDs). The LEDs provide backlighting to graphics or images provided on an upper surface of the user controls to provide improved visibility. To compensate for additional power required by the LEDs, the navigation control unit 1200 includes a power supply such as a battery 1204.

The LEDs 1202 change color depending upon the mode in which they are currently set. For example, the microprocessor 443 may command each LED to emit green light to illuminate associated user controls (e.g., buttons). If the user selects one of the user controls 122, the microprocessor 443 commands that associated LED to emit yellow light, while the remaining user controls are illuminated with green light. The microprocessor 443 may furthermore command an LED to emit red light as a reminder to the user. For example, if one of the user controls is programmed as an email hot key for the user's email provider, the navigation control unit 1200 may receive a signal from the email provider indicating that the user has received new email messages. In response, the microprocessor 443 may command the LED for the email hot key to emit red light, as opposed to green light, to notify the user. Of course, various other options are available for assigning colors to associated functions, modes, or user alerts.

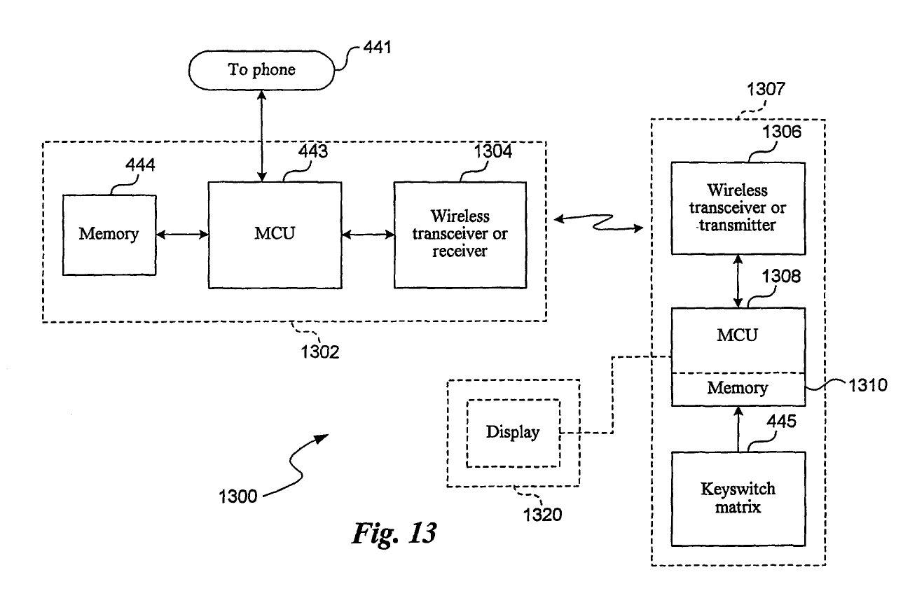

Referring to FIG. 13, another alternative embodiment is shown as a navigation system 1300 wherein the user controls 122 are remote from the wireless web access device 110. The wireless web access device 110 is linked with the navigation system 1300 by a communications link such as a local wireless link, which includes radio, microwave, infrared, ultrasonic, and any other form of communication. Examples of local wireless link protocols include Bluetooth, Home RF, IEEE 802.11. In this wireless link embodiment, the maximum range is approximately 10 feet in order to minimize operational requirements, but larger ranges are possible within the scope of the invention.

A first portion 1302 connects with the wireless web access device 110 and includes the microprocessor 443 and memory 444. This first portion also includes a wireless transceiver or receiver 1304 that communicates with another wireless transceiver or transmitter 1306 in a second, separate portion 1307. The second portion includes another microprocessor 1308 that includes on chip memory 1310. The key switch matrix 445 is then coupled to the microprocessor 1308. As a result, a wire or cord need not connect the user controls with the web access device.

The first and second portions 1302 and 1307 are preferably enclosed within separate housings. The second portion may take any form, such as a pen, where the user controls are buttons along a barrel of the pen. In this embodiment, a hands-free unit 230 may be optionally coupled to the second portion 1307 by a communications link such as a cord 233 or local wireless link. The first portion for connecting to the wireless web access device may be sold independently of the separate portion and may include more expensive circuitry. Less expensive circuitry may be provided in the second portion 1307, and include, as stored in the memory 1310, a serial number or separate identifier associated with, for example, a media corporation. The media corporation may then provide the second portion free as a promotional giveaway to users. The navigation server then maps the user controls 122 of the second portion 1307 to one or more websites (or web pages of a single site) associated with the media corporation. Users may receive multiple second portions 1307, each associated with a particular company, market, hobby, interest, or content, as described herein.

In an alternative embodiment, the second portion 1307 takes the form of a wristwatch and includes a display 1320 for displaying time and/or other information. The display may be a standard LCD display and may be coupled to the microprocessor i308. The second portion may provide numerous additional functions by combining additional functionality or elements described herein.

In another alternative embodiment, the second portion of 1307 takes the form of a remote control device. In this alternative embodiment, the wireless transceiver 1306 may be an infrared transmitter, or alternatively, a separate infrared transmitter may be provided. Thus, in this alternative, the second portion of 1307 may be used, for example, to control interactive TV, set-top boxes, Internet appliances, Internet enabled televisions or set-top boxes. Indeed, the wireless web access device 110 may be an interactive TV, set-top box, Internet appliance, Internet enabled television, or other network device coupled wirelessly or with wires to a network, such as the Internet. Thus, the second portion 1307 may be used both to redirect a browser on the interactive television or other network device to predetermined sites, as well as control functions of the interactive television, such as power, volume, channel selection, etc.

In yet another alternative embodiment, the second portion 1307 permits a user to access or communicate with a wireless Internet WAN. Thus, in this embodiment, the wireless transceiver 1306 may employ in wireless protocol employed by such wireless Internet WAN.

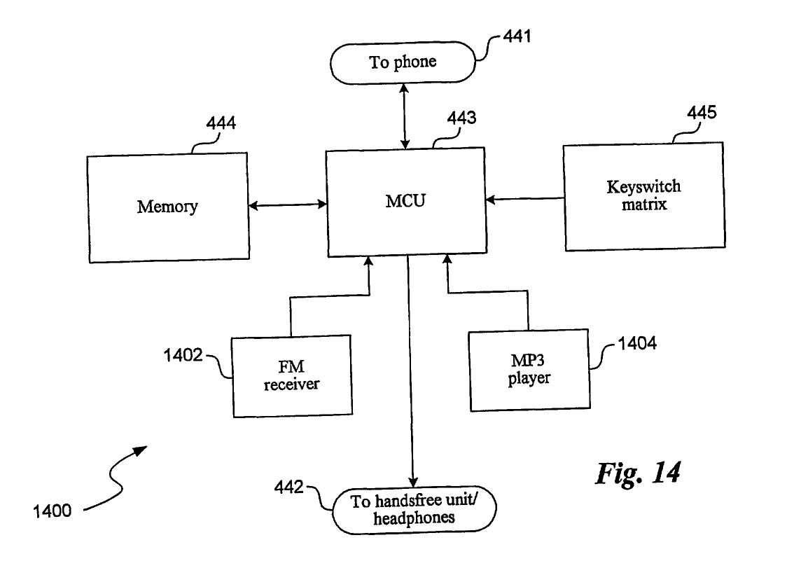

Referring to FIG. 14, an alternative navigation control unit 1400 is shown that includes additional circuitry and associated functionality. An FM receiver 1402 is coupled to the microprocessor 443. The FM receiver allows a user to receive music or FM broadcasts and listen to them over the earpiece. While an FM receiver is depicted, other receivers may be employed, such as an AM receiver.

A solid-state music player, such as an MP3 player 1404, is also coupled to the microprocessor 443. The MP3 player 1404 allows the user to retrieve, decode, and play audio files, such as files stored in the memory 444 or retrieved via the wireless web access device 110. While an MP3 player is depicted, other known audio playback devices may be provided. Alternative embodiments employ only the FM receiver or MP3 player. Further alternative embodiments may employ other media players, such as still or moving (e.g. video) image players, such as JPEG, MPEG or DVD players.

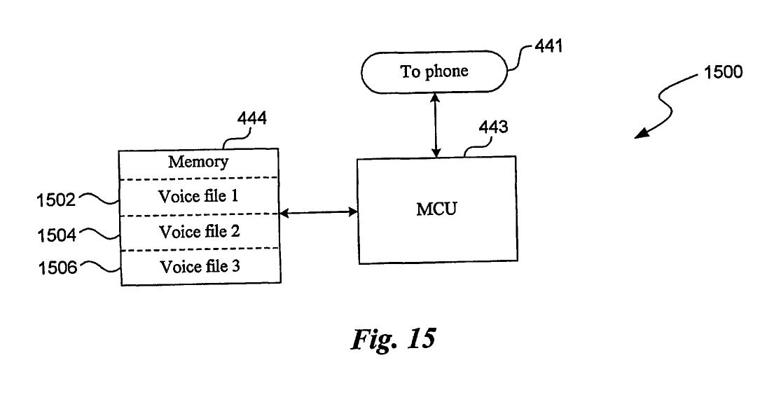

Referring to FIG. 15, another alternative navigation control unit is shown as a unit 1500 that omits the key switch matrix 445. Instead, the microprocessor 443 and memory 444 are configured to process voice commands. Thus, a user may navigate to a desired website with the web access device 110 by speaking commands into a microphone associated with either the web access device or a separate microphone coupled to the microprocessor 443. The memory 444 includes several voice files associated with the user. For example three voice files 1502, 1504, and 1506 may store voice commands for certain preprogrammed URLs. A user, upon initializing the navigation control unit 1500, speaks the name of each of three websites previously programmed for the unit. The microprocessor 443, in turn, stores each of the spoken names in one of the voice files. Thereafter, when the user speaks one of the stored names into the microphone, the microprocessor accesses the navigation server to access, as described herein, a preprogrammed or pre-designated website associated with that name.

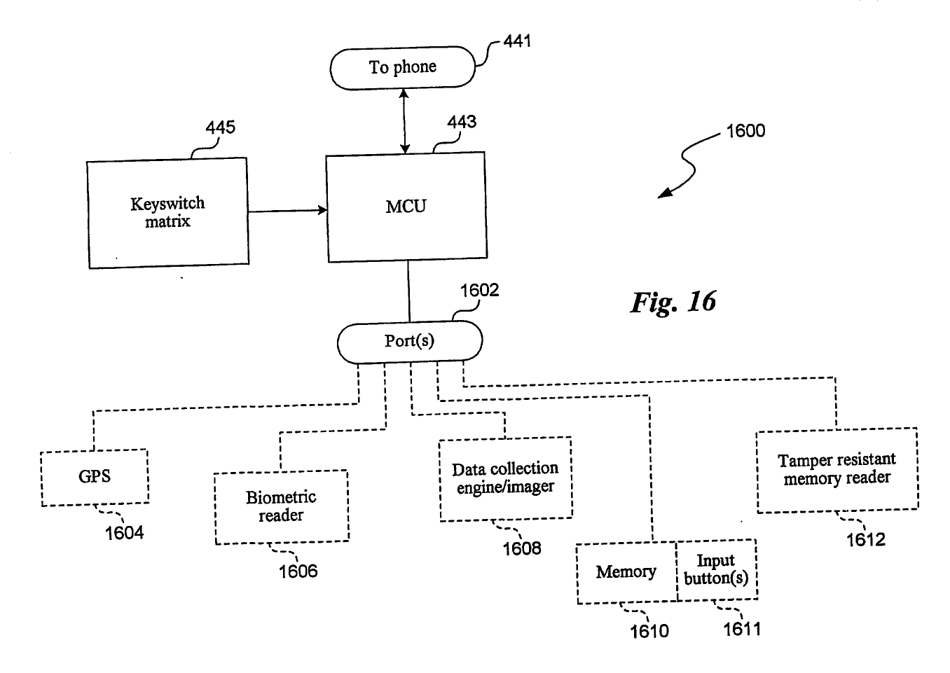

Referring to FIG. 16, an alternative navigation control unit 1600 permits reconfiguration of hardware components. The navigation control unit 1600 includes one or more ports 1602 that receive one or more optional modules for adding additional functionality to the navigation control unit. A global positioning system (“GPS”) module 1604 provides positioning data that indicates where the navigation control unit is currently located. Such location information may be displayed on the display screen 111, possibly together with map data retrieved from the Internet 115. Alternative embodiments may omit the GPS module, and instead rely on other location determining methods, such as cell site triangulation, sector and power level determination, and other location determining methods known by those skilled in the relevant art. Such location determining information may be generated or received by the navigation control unit, and communicated to the wireless device, or vice versa.

A biometric reader module 1606 includes one or more biometric reading devices, such as tactile sensors (such as for fingerprint sensing), retinal imagers, voice fingerprint analyzers, or other biometric readers known by those skilled in the art. Such a biometric reader module may operate as a security device to prohibit authorized users from using a particular navigation control unit assigned to a particular user. Thus, unauthorized users may not employ the hot keys and access websites associated with the hot keys (e.g., a website associated with the user's email inbox).

A data collection engine or imager module 1608 allows the navigation control unit 1600 to automatically collect data from data carriers such as bar codes, magnetic stripes, radio frequency identification tags (RFID tags), etc. The data collection engine module 1608 may take the form of any data collection device, such as a laser scanner, wand-type bar code reader, magnetic stripe reader, RFID reader, and like. If the data collection engine module is a magnetic stripe reader, the user may swipe his or her credit card through the reader to permit the navigation control unit to automatically capture the user's credit card number. The data collection engine module 1608 may also be a two-dimensional imager, such as a CCD camera.

The memory module 1610 allows the navigation control unit 1600 to accept removable and replaceable memory modules. The memory module may take any known form, such as PCMCIA cards, semiconductor chips with various packaging, floppy or hard disks, or other known memory devices, such as the memory stick manufactured by Sony. The memory module 1610 may be a Subscriber Identity Module (“SIM”). A SIM card includes a memory (and possibly associated processor) to encrypt voice and data transmissions, and identify a user on a mobile network has been a legitimate user. As a result, the SIM card module would permit access to a particular wireless network if the wireless device would otherwise be excluded from that network.

In one embodiment, the mobile device 110 may download from a server (such as the navigation server) software modules or additional functionality, which is stored in the memory of the navigation control unit. Alternatively, such additional software modules or added functionality may be stored in, or be provided by, the replaceable memory modules 1610. Such additional functionality may include software games, simple arithmetic utilities (e.g., a present value calculator), additional URLs, and other functionality described in this in the applications cited herein. For example, such additional functionality coiled be applications designed to facilitate business, such as order taking, inventory control, expense tracking, or local corporate data storage. In an inventory control environment, the navigation control unit may employ a data collection engine, such as a laser scanner. Overall, the navigation control unit 1600 may employ two or more of the modules shown in FIG. 16, or other components or functions described herein.

One embodiment of the memory module 1610 may include one or more optional input buttons 1611 or user input devices. The memory stores a URL, redirect address or link, which may be accessed by the user depressing the input button 1611. Thus, the user may plug the memory module 1610 into the navigation control unit to provide additional navigation capabilities for additional hot keys. Further information on this embodiment may be found in the U.S. patent application Ser. No. ______, entitled “Hardware Configuration For A Navigation Control Unit For A Wireless Computer Resource Access Device, Such As A Wireless Web Content Access Device.”

A tamper resistant memory module 1612 allows the navigation control unit 1600 to accept tamper resistant memory devices, such as smart cards. Some smart cards store encryption keys, electronic funds, or other important information. By providing the tamper resistant memory module 1612, the navigation control unit 1600 can retrieve data from smart cards and provide appropriate access (in the case of encryption keys), facilitate electronic commerce (in the case of electronic funds), and the like. The tamper-resistant memory 1612 may form part of a Public Key Infrastructure (“PKI”), where the tamper-resistant memory and the navigation server share one or more public—private key pairs. is As a result, the navigation control unit permits robust encryption. Many other modules are possible, such as modules for Bluetooth-enabled circuitry, removable chips, electronic cash devices, electronic commerce devices, electronic wallet devices, pagers, beepers, etc. The memory modules 1610 or 1612, or the memory 444 of the navigation control unit itself, may store account information such as a user's credit card number to facilitate electronic commerce transactions or such information may be provided at the navigation server.

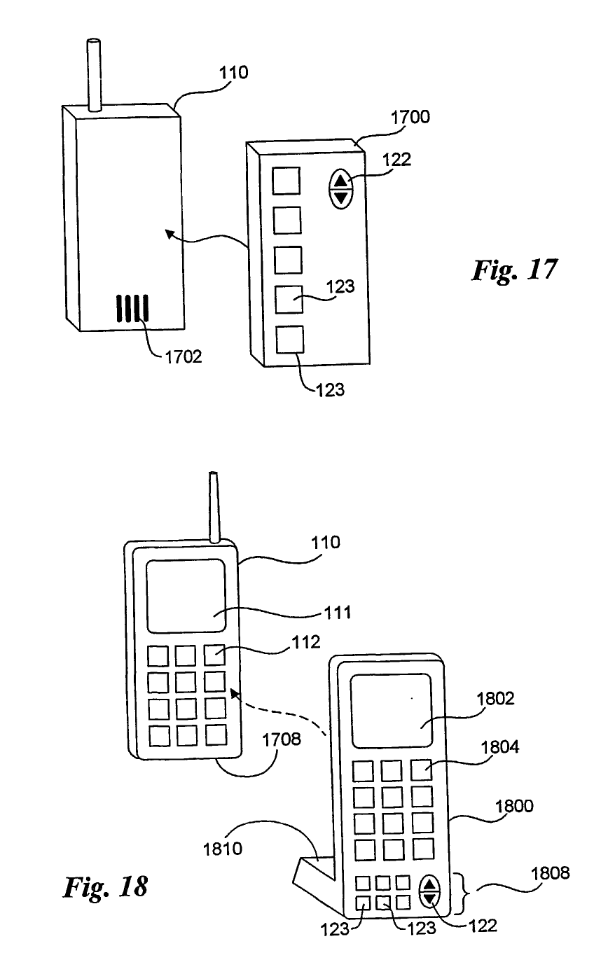

While the navigation control unit is generally described herein as being a separate device associated with the web access device (such as part of a hands-free headset of a cell phone), numerous other alternatives are possible. Referring to FIG. 17, an alternative embodiment combines the navigation control unit with a rechargeable battery 1700. The rechargeable battery includes the user controls 122 and hot keys 123 provided on an outer surface of the battery. The battery 1700 is of a size and shape for securing to the web access device and connects to control signal terminals 1702 provided on the web access device.

In another alternative embodiment, the navigation control unit operates as a component in a house arrest or security device. Thus, the navigation control unit 1600 (alone or together with the wireless Web access device) is secured to or carried by an individual. The navigation control unit may include the GPS module to determine the location of the individual, although other embodiments may employ other means for locating the individual. Information regarding a location of the individual may be related wirelessly over a network to a central computer (such as the navigation server), which can track and monitor a location of the individual throughout the day to ensure that the individual complies with a predetermined plan.

Referring to FIG. 18, the navigation control unit is combined with a removable face plate 1800 that secures to the web access device 110. The face plate 1800 includes a window 1802 and button portions 1804 that align or coincide with the display screen 1100 and integral control buttons 112, respectively. Where a standard front face of the web access device fails to provide sufficient room to accommodate the user controls 122 and hot keys 123, an additional portion 1808 may be provided, which is shown as extending below the web access device. Terminals 1810 couple to be control signal terminals 1702 when the face plate 1800 is secured to the web access device.

The navigation control unit 125 may be incorporated into any removable or replaceable element for a wireless web access device 110. For example, the navigation control unit 125 may be configured within a replaceable antenna of a mobile phone. The navigation control unit may be employed with any Internet enabled device, such as wireless devices, and permits reprogramming or “macro-like” programming of user controls or keys to permit users to perform actions or functions permitted by the Internet enabled device where such actions often require multiple key presses or user input actions on the Internet enabled device.

The navigation control unit 125 may be configured for particular vertical markets, industries, hobbies, or interests of groups of users. Thus, an organization may target a particular market segment of users and preprogram the hot keys to access only desired content over a network (and possibly permit the user to reprogram a subset of the user controls). Furthermore, the navigation control unit may include additional functionality depending upon the particular vertical market to which the device is to be used. For example, if the navigation control unit is to be employed by a corporation executive, then the hot keys may be programmed to access the executive's corporate email inbox, a corporate scheduling system, the corporate intranet, and the corporate extranet. The navigation control unit may also include the biometric reader module 1606 or tamper resistant memory module 1612 to provide a security measure that prohibits unauthorized users from accessing the executive's sites programmed by the hot keys.

While aspects of the invention are generally described herein for use with a web access device such as a cell phone, aspects of the invention may be employed with other computer system configurations including Internet appliances, hand-held devices, wearable computers, mobile phone devices, multiprocessor systems, microprocessor-based or programmable consumer electronics, set-top boxes, network PCs, mini-computers, mainframe computers, and the like. The invention can be embodied in a special purpose computer or data processor that is specifically programmed, configured, or constructed to perform one or more of the computer-executable instructions explained in detail below. Indeed, the term “computer”, as used generally herein, refers to any of the above devices, as well as to any data processor.

The invention can also be practiced in distributed computing environments where tasks or modules are performed by remote processing devices and which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media including magnetic and optically readable and removable computer discs stored as firmware in chips (e.g., EEPROM chips), as well as distributed electronically over the Internet or over other networks (including wireless networks). Those skilled in the relevant art will recognize that portions of the invention may reside on a server computer while corresponding portions reside on a client computer. Data structures and transmission of data particular to aspects of the invention are also encompassed within the scope of the invention.

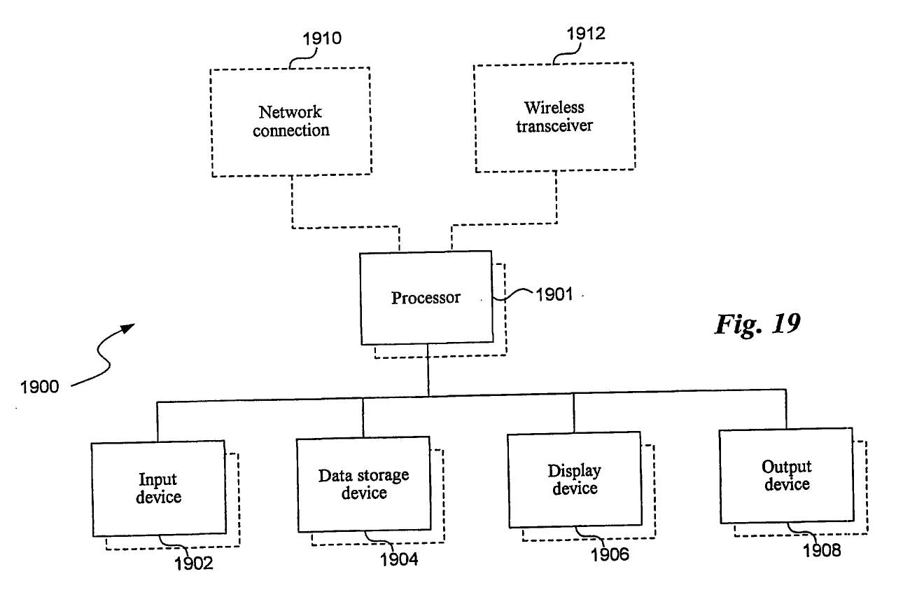

Referring to FIG. 19, one embodiment of the invention employs a computer 1900, such as a personal computer or workstation, having one or more processors 1901 coupled to one or more user input devices 1902 and data storage devices 1904. The computer is also coupled to at least one output device such as a display device 1906 and one or more optional additional output devices 1908 (e.g., printer, plotter, speakers, tactile or olfactory output devices, etc.). The computer may be coupled to external computers, such as via an optional network connection 1910, a wireless transceiver 1912, or both.

The input devices 1902 may include a keyboard and/or a pointing device such as a mouse. Other input devices are possible, such as a microphone, joystick, pen, game pad, scanner, digital camera, video camera, and the like. The data storage devices 1904 may include any type of computer-readable media that can store data accessible by the computer 1900, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN), or the Internet (not shown in FIG. 1).

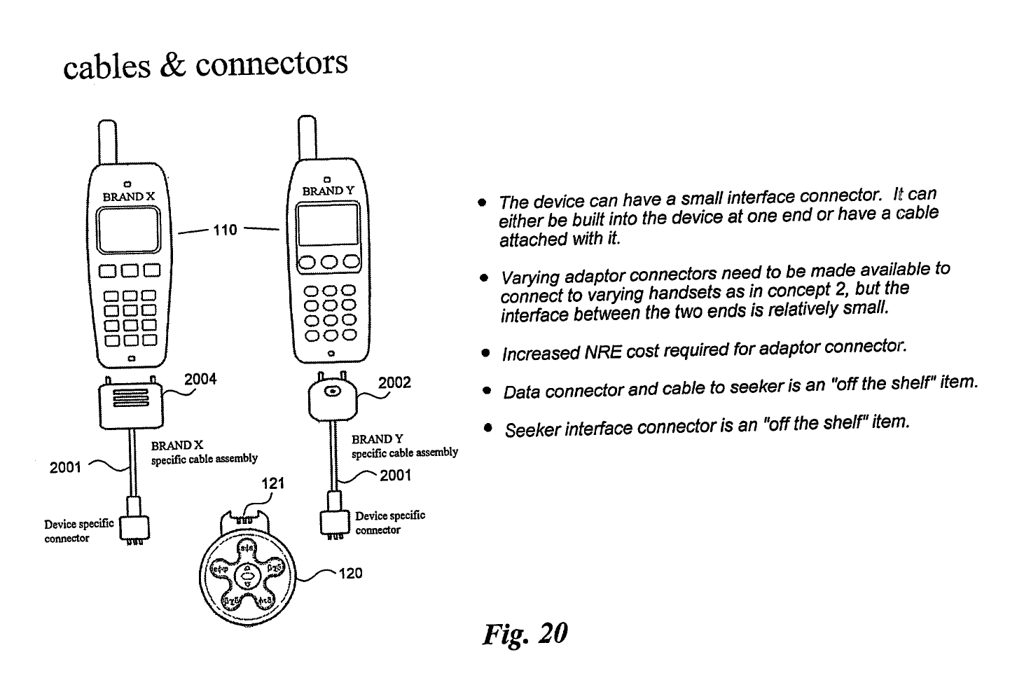

Referring to FIG. 20, and alternative embodiment employs a interface connector 2001 that includes plugs at each end, one that couples to the navigation control unit 120, and another that operates as a interface plug for the wireless device 110. A first interface connector 2001 includes an adapter 2002 to connect with a command terminal or socket associated with a first type of wireless device 110. The first adapter 2002 may include memory for re-programming or initializing the first type of wireless device, as described herein, such as with respect to FIG. 5. Likewise, the second interface connector 2001 includes an adapter 2004 to connect with a command terminal or port associated with a second type of wireless device 110. Again, the adapter 2004 may include memory for reprogramming or customizing the second wireless device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other systems, not necessarily for the web-based system generally described above. For example, the navigation control unit may be used to access content or information stored on a LAN, access different pages of a single site on a network, or even access resources of a single stand-alone computer. Thus, under an alternative embodiment, the navigation control unit and hot keys may be configured to access only certain pages of content or resources available from a single stand-alone computer. The elements and acts of the various embodiments described above ca be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all media delivery systems that operate under the claims to provide a method for providing link character streams with associate aural content. Accordingly, the invention is not limited by the disclosure, but instead, the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. An apparatus for providing access to web content from the Internet, the apparatus comprising:
a mobile phone configured for communicating wirelessly with the Internet, wherein the mobile phone includes a browser and a display screen;
a web navigation control unit coupled to the mobile phone, wherein the web navigation control unit comprises:
an interface configured for coupling with the mobile phone;
two or more user input buttons; and
circuitry including a processor, wherein the circuitry is coupled to the interface and to the user input buttons, and wherein the circuitry is configured to:
generate and transmit to the mobile phone a user command based on actuation of one of the buttons, wherein the user command includes an identification of the one button actuated, an identification of the navigation control unit and a URL; and
wherein, based on the URL, the mobile phone:
transmits the user command to a navigation server coupled to the Internet;
receives a redirection command from the navigation server based on the identification of the one button actuated and the identification of the navigation control unit, wherein the redirection command includes an address of a web page on the Internet; and
accesses the address specified in the redirection command using the browser and retrieves the web page for display on the display screen.

2. The apparatus of claim 1, further comprising:
a hands free headset having a microphone and ear piece;
an electrical cord coupling the hands free headset and the navigation control unit to the mobile phone; and
a semiconductor memory coupled to the microprocessor, wherein the memory stores at least the identification of the navigation control unit and the URL;
wherein the user input buttons include:
a first set of navigation buttons for automatically navigating to a first set of predetermined web pages, wherein the first set of predetermined web pages are not determined by the user;
a second set of navigation buttons for automatically navigating to a second set of predetermined web pages, wherein the second set of predetermined web pages are preprogrammed by the user; and
a third set of navigation buttons for receiving user commands to move within the web page or between web pages.

3. The apparatus of claim 1, further comprising:
a port for receiving an added functionality module, wherein the port electrically couples the added functionality module with the circuitry for communication therewith, and wherein the added functionality module is: a display screen, a touch-sensitive screen, two or more multicolored lights, a battery, a solar cell a local wireless transceiver, an FM receiver, an MP3 player, a voice recognition module, a global positioning system module, a biometric reader, a data collection engine, a digital camera, expanded memory or tamper-resistant memory.

4. An apparatus for connection with a mobile wireless computer resource access device, the apparatus comprising:
a navigation control unit comprising:
a communication interface configured for releasably securing at least a portion of the navigation control unit with the mobile wireless computer resource access device and for providing signal communication from the navigation control unit to the wireless computer resource access device;
user controls for providing user-input signals; and
circuitry including a processor and memory, wherein the circuitry is coupled to the interface and to the user controls, and wherein the circuitry is configured to:
generate a computer resource access command based on user operation of the user controls,
transmit the computer resource access command to the wireless computer resource access device, and
wherein the computer resource access command includes a URL stored in the memory.

5. The apparatus of claim 4 wherein the mobile wireless computer resource access device includes a mobile phone, wherein the mobile phone includes a browser for accessing computer resources from the Internet, wherein the computer resources include web pages, wherein the user controls include a keyswitch matrix, and wherein the navigation control unit further comprises:
a hands free headset having a microphone and ear piece; and
an electrical cord coupling the hands free headset and the navigation control unit to the mobile phone.

6. The apparatus of claim 4 wherein the mobile wireless computer resource access device includes a mobile phone, wherein the mobile phone includes a browser for accessing computer resources from the Internet, wherein the computer resources include web pages, wherein the mobile phone is programmed to automatically access a predetermined web site, and wherein the circuitry is further configured to:
automatically initialize the mobile phone and reprogram the predetermined web site to an alternative web site.

7. The apparatus of claim 4 wherein the user controls comprise:
a first set of navigation buttons for automatically navigating to a first set of predetermined web pages, wherein the first set of predetermined web pages are not determined by a user;
a second set of navigation buttons for automatically navigating to a second set of predetermined web pages, wherein the second set of predetermined web pages are selectable by the user; and
a third set of navigation buttons for receiving user commands to move within a web page or between web pages.

8. The apparatus of claim 4, further comprising:
an audio signal source coupled to the circuitry for providing two or more user selectable audible signals, and wherein the mobile wireless computer resource access device includes a mobile phone that provides audible signals different from the two or more user selectable audible signals.

9. The apparatus of claim 4 wherein the navigation control unit is at least partially retained within an antenna, face-place or rechargeable battery, and wherein the antenna, face-place and rechargeable battery are connectable and user removable with respect to the mobile wireless computer resource access device.

10. An apparatus for a mobile wireless computer resource access device for accessing at least one computer resource via a network, the apparatus comprising:
a microprocessor coupled to communicate with the mobile wireless computer resource access device, wherein the microprocessor is user removable with respect to the mobile wireless computer resource access device;
user input circuitry coupled to the microprocessor;
memory coupled to the microprocessor, wherein the memory stores
information identifying the apparatus and
at least one network address for the computer resource, and
wherein the microprocessor is configured to
process user input signals received from the user input circuitry and
command the mobile wireless computer resource access device to access the computer resource from the network based on the network address stored in the memory and the user input signals.

11. The apparatus of claim 10 wherein the memory is monolithically integrated with the microprocessor.

12. The apparatus of claim 10 wherein the mobile wireless computer resource access device is programmed to automatically access a predetermined computer resource, and wherein the microprocessor is further configured to:
automatically reprogram the mobile wireless computer resource access device to access an alternative computer resource.

13. The apparatus of claim 10, further comprising a battery coupled to the microprocessor.

14. The apparatus of claim 10, further comprising a solar cell coupled to the microprocessor.

15. The apparatus of claim 10, further comprising a removable power source coupled to the microprocessor.

16. The apparatus of claim 10 wherein the user input circuitry includes a first set of navigation buttons for automatically navigating to a first set of predetermined computer resources, wherein the first set of predetermined computer resources are not determined by a user.

17. The apparatus of claim 10 wherein the user input circuitry includes a second set of navigation buttons for automatically navigating to a second set of predetermined computer resources, wherein the second set of predetermined computer resources are selectable by the user.

18. The apparatus of claim 10 wherein the user input circuitry includes a third set of navigation buttons for receiving user commands to move within a web page or between web pages.

19. The apparatus of claim 10 wherein the user input circuitry includes a thumb pad switch.

20. The apparatus of claim 10 wherein the user input circuitry includes a thumb wheel.

21. The apparatus of claim 10, further comprising a liquid crystal display (“LCD”) screen coupled to the microprocessor, wherein the LCD differs from a display of the mobile wireless computer resource access device.

22. The apparatus of claim 10 wherein the user input circuitry includes a touch-sensitive display coupled to the microprocessor, wherein the touch-sensitive display differs from a display of the mobile wireless computer resource access device.

23. The apparatus of claim 10 wherein computer resource is an electronic commerce web site, and wherein the user input circuitry includes a buy button to automatically purchase a product or service from web site.

24. The apparatus of claim 10 wherein the user input circuitry includes at least one light emitting element for emitting light of first and second colors, and wherein the microprocessor provides a first signal to the light emitting element for emitting light of the first color in a first mode of operation for the apparatus, and provides a second signal to the light emitting element for emitting light of the second color in a second mode of operation for the apparatus.

25. The apparatus of claim 10, further comprising first and second separate housings, wherein the first housing at least partially secures the microprocessor and a wireless receiver, wherein the microprocessor is coupled to the wireless receiver, and
wherein the second housing at least partially secures the user input circuitry and a wireless transmitter for transmitting the input signals to microprocessor via the wireless receiver.

26. The apparatus of claim 10 wherein the user input circuitry is configured for transmitting the input signals to microprocessor via a local wireless link, and wherein the wireless link is a radio frequency, ultrasound or infrared link.

27. The apparatus of claim 10, further comprising first and second separate housings, wherein the first housing at least partially secures the microprocessor and a wireless receiver, wherein the microprocessor is coupled to the wireless receiver, and
wherein the second housing at least partially secures the user input circuitry and a wireless transmitter for transmitting the input signals to microprocessor via the wireless receiver, and wherein the second housing is shaped like a pen.

28. The apparatus of claim 10, further comprising first and second separate housings, wherein the first housing at least partially secures the microprocessor and a wireless receiver, wherein the microprocessor is coupled to the wireless receiver, and
wherein the second housing at least partially secures the user input circuitry, a display, clock circuitry and a wireless transmitter, wherein the transmitter is configured for transmitting the input signals to microprocessor via the wireless receiver, and wherein the second housing is shaped like a wristwatch.

29. The apparatus of claim 10, further comprising an FM receiver.

30. The apparatus of claim 10, further comprising a stored audio decoder coupled to the microprocessor for decoding stored audio for playback to a user.

31. The apparatus of claim 10 wherein the user input circuitry comprises voice commands for receiving spoken user input and generating the user input signals.

32. The apparatus of claim 10, further comprising a port for receiving a user-removable added functionality module, wherein the port electrically couples the added functionality module with the microprocessor for communication therewith.

33. The apparatus of claim 10, further comprising location determining circuitry.

34. The apparatus of claim 10, further comprising a tactile sensor coupled to the microprocessor for receiving tactile input signals.

35. The apparatus of claim 10 wherein the microprocessor is further configured to compare spoken user input to a stored voice fingerprint file stored in the memory.

36. The apparatus of claim 10, further comprising a CCD imager coupled to the microprocessor.

37. The apparatus of claim 10, further comprising a bar code reader coupled to the microprocessor.

38. The apparatus of claim 10, further comprising a port for receiving a tamper resistant memory module.

39. The apparatus of claim 10, further comprising a port for receiving a memory module.

40. The apparatus of claim 10 wherein the user input circuitry includes two or more buttons for automatically accessing two different pages of a single node on the network.

41. The apparatus of claim 10 wherein the microprocessor and memory are configured to access the computer resources of a single computer.

42. An apparatus for a mobile wireless computer resource access device for accessing at least one computer resource via a network, the apparatus comprising:
memory means for storing information identifying the apparatus and at least one network address for the computer resource;
user input means for receiving user input;
processing means, coupled to the memory and user input means, for processing user input and generating commands for the mobile wireless computer resource access device to access the computer resource from the network based on the network address stored in the memory and the user input; and
interface means, coupled between the processing means and the mobile wireless computer resource access device, for providing the commands to the mobile wireless computer resource access device.

43. A mobile phone apparatus for accessing at least one computer resource via a network the apparatus comprising:
a transceiver configured for communicating wirelessly with the network;
a microphone;
an audio output device;
user input buttons;
at least one hot key associated with a URL;
a visual display device; and
circuitry including memory and a microprocessor coupled to the transceiver, microphone, audio output device, user input buttons, hot key and the display device, wherein the memory stores the URL, and wherein the circuitry is configured to automatically generate an access command based on actuation of the hot key the URL and request, via the network, the computer resource.
